(19) United States
(12) Patent Application Publication
(10) Pub. No.: US 2025/0007374 A1
(43) Pub. Date: Jan. 2, 2025

(54) OUTER ROTOR MOTOR AND UNMANNED AERIAL VEHICLE APPARATUS

(71) Applicant: AUTEL ROBOTICS CO., LTD., Nanshan Dist. (CN)

(72) Inventor: Feifei SHAO, Shenzhen (CN)

(21) Appl. No.: 18/759,853

(22) Filed: Jun. 29, 2024

(30) Foreign Application Priority Data
Jun. 29, 2023 (CN) 202310794779.8

(51) Int. Cl. H02K 21/22; B64U 30/20; B64U 101/00; H02K 1/2791

(52) U.S. Cl. CPC H02K 21/22; B64U 30/20; H02K 1/2791; B64U 2101/00; H02K 2201/03; H02K 2213/03

(57) ABSTRACT

The present disclosure discloses an outer rotor motor and an unmanned aerial vehicle apparatus. The outer rotor motor includes a rotor assembly and a stator assembly. The rotor assembly includes a plurality of permanent magnet rotor elements. The stator assembly includes a stator yoke and a plurality of stator teeth disposed in a circumferential direction of the stator yoke. An air gap is used to separate the rotor assembly and the stator assembly with a gap and in an air gap between an outer arc surface of the stator tooth facing the air gap and an inner arc surface of the permanent magnet rotor element facing the air gap. A gap of a middle section of the air gap is less than gaps of two ends of the air gap.

### CROSS REFERENCE TO RELATED DISCLOSURE

This application is filed based upon and claims priority to Chinese patent application 202310794779.8, filed on Jun. 29, 2023 and entitled “OUTER ROTOR MOTOR AND UNMANNED AERIAL VEHICLE APPARATUS” the entire disclosure of which is incorporated herein by reference for all purposes.

### BACKGROUND

A motor is one of driving elements of an unmanned aerial vehicle and a traditional unit motor with even air gaps is an outer rotor permanent magnet brushless direct current motor with 14 poles and 12 slots and has relatively high power density. However, the motor with even air gaps has larger tooth-slot torque peak value and counter electromotive force waveform distortion rate, resulting in higher tangential torque pulsation and relatively greater noise of the motor.

It is therefore necessary to improve the prior art to overcome the disadvantages of the prior art.

### SUMMARY

Therefore, a technical problem to be resolved in the present disclosure is a problem in the prior art that use efficiency is poor and noise is high due to even air gaps in the motor.

To resolve the foregoing technical problem, the present disclosure provides an outer rotor motor. The outer rotor motor includes a rotor assembly, the rotor assembly including a plurality of permanent magnet rotor elements; a stator assembly, the stator assembly including a stator yoke and a plurality of stator teeth disposed in a circumferential direction of the stator yoke; and an air gap, the air gap being configured to separate the rotor assembly and the stator assembly with a gap; in an air gap between an outer arc surface of the stator tooth facing the air gap and an inner arc surface of the permanent magnet rotor element facing the air gap, a gap of a middle section of the air gap is less than gaps of two ends of the air gap.

The present disclosure further provides an unmanned aerial vehicle apparatus, where the unmanned aerial vehicle apparatus includes the foregoing outer rotor motor.

The technical solution provided in the present disclosure has the following advantages:

An outer rotor motor provided by the present disclosure includes a rotor assembly and a stator assembly, the rotor assembly includes a plurality of permanent magnet rotor elements, the stator assembly includes a stator yoke and a plurality of stator teeth disposed in a circumferential direction of the stator yoke, an air gap is used to separate the rotor assembly and the stator assembly with a gap and in an air gap between an outer arc surface of the stator tooth facing the air gap and an inner arc surface of the permanent magnet rotor element facing the air gap, a gap of a middle section of the air gap is less than gaps of two ends of the air gap.

It can be learned from the foregoing that in the outer rotor motor adopted in the present disclosure, because an air gap between an end surface of the stator tooth facing the permanent magnet rotor element and the permanent magnet rotor element is an uneven air gap, compared with the prior art, the outer rotor motor in the present disclosure has relatively high power density and lower tooth-slot torque peak value and counter electromotive force distortion rate.

### BRIEF DESCRIPTION OF THE DRAWINGS

To describe the technical solutions in the embodiments of the present disclosure or in existing technologies more clearly, the accompanying drawings required for describing the embodiments or existing technologies are briefly described below. Apparently, the accompanying drawings in the following description show some embodiments of the present disclosure and a person of ordinary skill in the art may still derive other drawings from these accompanying drawings without creative efforts.

FIG. 1 is a schematic structural diagram of an outer rotor motor according to the present disclosure;

FIG. 2 is a schematic structural diagram of a stator assembly according to the present disclosure;

FIG. 3 is a schematic structural diagram of a rotor assembly according to the present disclosure;

FIG. 4 is a schematic structural diagram of an air gap according to the present disclosure;

FIG. 5 is a schematic diagram of a counter electromotive force waveform distortion rate under a combination of a slot width of a stator slot and a width of a permanent magnet rotor element according to the present disclosure;

FIG. 6 is a schematic diagram of a tooth-slot torque peak value under a combination of a slot width of a stator slot and a width of a permanent magnet rotor element according to the present disclosure;

FIG. 7 is a schematic diagram of a fundamental wave counter electromotive force value under a combination of a slot width of a stator slot and a width of a permanent magnet rotor element according to the present disclosure;

FIG. 8 is a schematic diagram of a counter electromotive force waveform distortion rate under a combination of an arc angle of a second arc segment and a distance between a center of the second arc segment and a center of a third arc segment according to the present disclosure;

FIG. 9 is a schematic diagram of a tooth-slot torque peak value under a combination of an arc angle of a second arc segment and a distance between a center of the second arc segment and a center of a third arc segment according to the present disclosure; and

FIG. 10 is a schematic diagram of a fundamental wave counter electromotive force value under a combination of an arc angle of a second arc segment and a distance between a center of the second arc segment and a center of a third arc segment according to the present disclosure.

Descriptions of reference numerals:
10. rotor magnet yoke; 20. permanent magnet rotor element; 210. outer edge; 220. inner edge; 30. rotating shaft; 40. stator tooth; 410. first end surface; 411. first arc segment; 412. second arc segment; 413. third arc segment; 50. stator winding; 60. air gap; and 70. stator yoke.

### DETAILED DESCRIPTION

The following clearly and completely describes the technical solutions in the present disclosure with reference to the accompanying drawings. Apparently, the described embodiments are some of the embodiments of the present disclosure rather than all of the embodiments. The following describes the present disclosure in detail with reference to the accompanying drawings and with reference to the embodiments. It should be noted that, the embodiments in the present disclosure and features in the embodiments may be mutually combined in case that no conflict occurs.

It should be noted that, in the specification, claims and accompanying drawings of the present disclosure, the terms “first”, “second” and so on are intended to distinguish between similar objects but do not necessarily indicate a specific order or sequence.

In the present disclosure, in a case in which no opposite description is provided, the used orientation words such as “upper, lower, top and bottom” are generally used for directions shown in the accompanying drawings, or vertical, perpendicular, or gravity directions for a component itself. Similarly, for ease of understanding and description, “inside, outside” refer to inside and outside of a contour of each component, but the foregoing orientation words are not used to limit the present disclosure.

### Embodiment 1

The present disclosure resolves a problem that use efficiency is poor and noise is high due to even air gaps in a motor.

It should be noted that, a stator winding 50 is disposed between two adjacent stator teeth 40 in a stator assembly and a permanent magnet rotor element 20 is disposed on an inner surface of a rotor magnet yoke 10. The permanent magnet rotor element 20 generates magnetic density in an air gap, so that magnetic density generated when the stator winding 50 is energized drives a rotor assembly to rotate. There have to be a gap between the rotor assembly and the stator assembly, that is, an air gap, to ensure normal rotation of the rotor assembly. In addition, a stator outer tooth and an inner edge 220 facing the permanent magnet rotor element 20 can cause fundamental wave magnetic density and other high-order harmonic wave magnetic density (collectively referred to as harmonic wave magnetic density) that are caused in the air gap, which thereby generate a tangent moment to the stator assembly and the rotor assembly by means of self-coupling and mutual coupling.

Harmonic wave magnetic density generated by a traditional even air gap magnetic field generates a relatively large tangential pulsation torque after coupling, which causes a relatively large tangential torque pulsation. In a traditional method, a harmonic wave magnetic density amplitude is weakened by reducing a magnetic steel width, that is, a width Mag of the permanent magnet rotor element 20, changing a slot width bso of a stator slot, or increasing an air gap, so as to reduce a tooth-slot torque peak value and a counter electromotive force waveform distortion rate, but while reducing the harmonic wave magnetic density amplitude, a fundamental wave magnetic density amplitude is also reduced, a fundamental wave counter electromotive force amplitude of a motor is reduced and power density of an outer rotor motor is also reduced.

In the present disclosure, an air gap of an outer rotor motor is circumferentially designed as an uneven air gap, so as to ensure that a fundamental wave magnetic density peak value remains unchanged. In addition, a relatively large harmonic wave torque caused by a high-order air gap magnetic density can be effectively weakened, ensuring that a rotor motor has relatively large power density, vibration noise caused by a tangential torque pulsation of the rotor motor can be reduced and flight stability of an aerial vehicle can be improved.

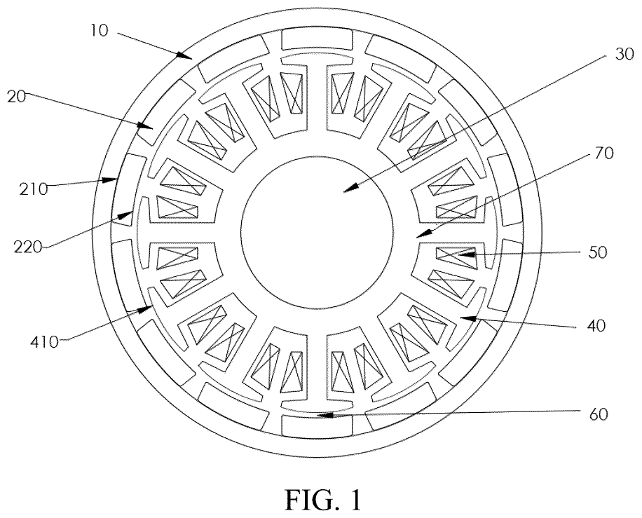

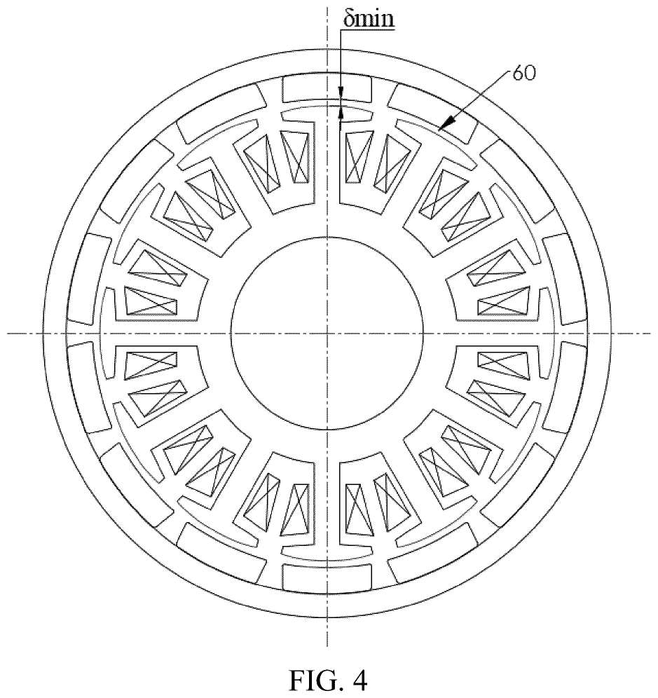

As shown in FIG. 1 to FIG. 10, an outer rotor motor includes a rotor assembly and a stator assembly. The rotor assembly includes a rotating shaft 30, an annular rotor magnet yoke 10 and a permanent magnet rotor element 20. The permanent magnet rotor element 20 is disposed on an inner peripheral surface of the rotor magnet yoke 10. An annular mounting area is formed between the permanent magnet rotor element 20 and the rotating shaft 30. The stator assembly is mounted inside the mounting area. The stator assembly includes a stator yoke 70 and a plurality of stator tooth 40 disposed in a circumferential direction of the stator yoke 70. The stator yoke 70 is sleeved on the rotating shaft 30 and rotatably cooperates with the rotating shaft 30. An air gap 60 is formed between an end surface of the stator tooth 40 away from the stator yoke 70 and an inner edge 220 of the permanent magnet rotor element 20. The end surface of the stator tooth 40 away from the stator yoke 70 has a first arc segment 411, a second arc segment 412 and a third arc segment 413 that are connected in a circumferential direction in sequence. Centers of the first arc segment 411, the second arc segment 412 and the third arc segment 413 do not overlap.

The first arc segment 411, the second arc segment 412 and the third arc segment 413 that are connected in the circumferential direction cooperate to form a first end surface 410. An uneven air gap 60 is formed between the first end surface 410 and the inner edge 220 of the permanent magnet rotor element 20.

Specifically, in the outer rotor motor adopted in the present disclosure, because the first arc segment 411, the second arc segment 412 and the third arc segment 413 that are on the end surface of the stator tooth 40 facing the permanent magnet rotor element 20 are not concentric, the air gap 60 between the stator tooth 40 and the permanent magnet rotor element 20 is an uneven air gap 60 and compared with the prior art, the outer rotor motor in the present disclosure has relatively high power density and a tooth-slot torque peak value and a counter electromotive force distortion rate are lower.

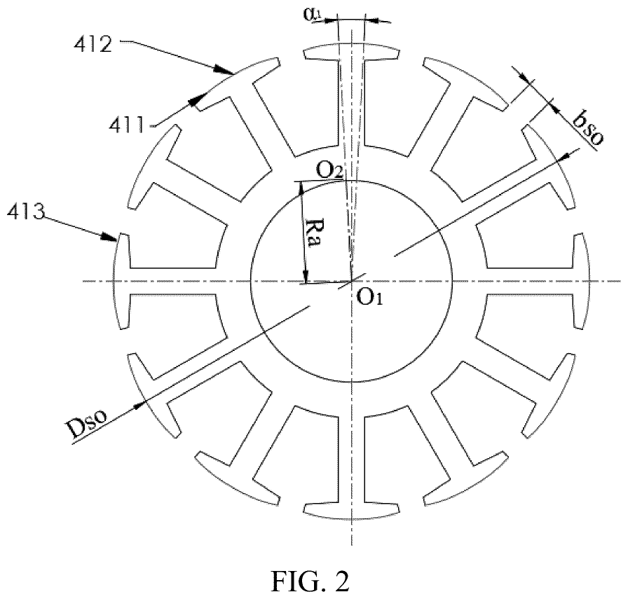

Further, the second arc segment 412 and the rotating shaft 30 are concentric, as shown in O1 in FIG. 2, so as to implement that distances between second arc segments 412 on a plurality of stator convex teeth and the rotating shaft 30 are equal. A plurality of second arc segments 412 are evenly distributed on an outer side of the rotating shaft 30, so as to facilitate a relative position of the stator assembly and the rotor assembly.

Further, to ensure that the air gap 60 is an uneven air gap and the air gap 60 changes according to a specific rule, so as to reduce a counter electromotive force distortion rate and a tooth-slot torque peak value of the outer rotor motor and ensure that the outer rotor motor has a relatively high fundamental wave counter electromotive force value, in the present disclosure, the first arc segment 411 and the third arc segment 413 are symmetrically disposed at two ends of the second arc segment 412, so as to cooperate the first arc segment 411, the second arc segment 412 and the third arc segment 413 to form an uneven air gap 60 with the inner edge 220 of the permanent magnet rotor element 20.

Further, as shown in 02 in FIG. 2, the first arc segment 411 and the third arc segment 413 are concentrically disposed. That is, the first arc segment 411 and the second arc segment 412 are on a track of a same circle, so that an air gap 60 formed at radians of the first arc segment 411 and the second arc segment 412 is even.

In this embodiment, a radius of curvature of the second arc segment 412 is greater than a radius of curvature of the first arc segment 411 and that of the third arc segment 413, so that a distance between the second arc segment 412 and the inner edge 220 of the permanent magnet rotor element 20 is a minimum distance of a gap. That is, the distance between the second arc segment 412 and the permanent magnet rotor element 20 is less than a distance between each of the first arc segment 411 and the third arc segment 413 and the permanent magnet rotor element 20. An uneven air gap 60 that is wide at two ends and narrow in the middle is formed at an air gap 60 between the stator convex tooth and the permanent magnet rotor element 20.

As shown in FIG. 1 to FIG. 10, the plurality of stator teeth 40 are disposed at equal intervals in the circumferential direction of the stator yoke 70 to form a plurality of stator slots. The outer rotor motor further includes a stator winding 50. The stator winding 50 is disposed around the stator teeth 40 and runs through the stator slots. 14p permanent magnet rotor elements 20 are disposed and 12p stator teeth 40 are disposed.

Specifically, the present disclosure describes an outer rotor motor with a 14-pole 12-slot structure.

In the present disclosure, when different combinations of the slot width bso of the stator slot and the width Mag of the permanent magnet rotor element 20 are selected, a MAP cloud diagram of a counter electromotive force waveform distortion rate, a tooth-slot torque peak value and a fundamental wave counter electromotive force value of the motor is shown.

Further, when a slot width bso of each stator slot meets 0.77*Dso*sin(7*p*π/(4*LCM(12p,14p))≤bso≤0.91*Dso*sin(7*p*π/(4*LCM(12p,14p)), where Dso is a diameter of the second arc segment 412 and LCM(12p, 14p) is a minimum keyway common multiple; and the width Mag of the permanent magnet rotor element 20 meets 0.81*Dso*π/(14p)≤Mag≤0.89*Dso*π/(14p), where Dso is a diameter of the second arc segment 412 and LCM(12p, 14p) is a minimum keyway common multiple, a tooth-slot torque peak value and a counter electromotive force waveform distortion rate of the outer rotor motor are both relatively low and a fundamental wave counter electromotive force value remains unchanged. Because the radius of curvature of the second arc segment 412 is greater than the radius of curvature of the first arc segment 411 and that of the third arc segment 413, the diameter of the second arc segment is equivalent to an outer diameter of the stator tooth 40.

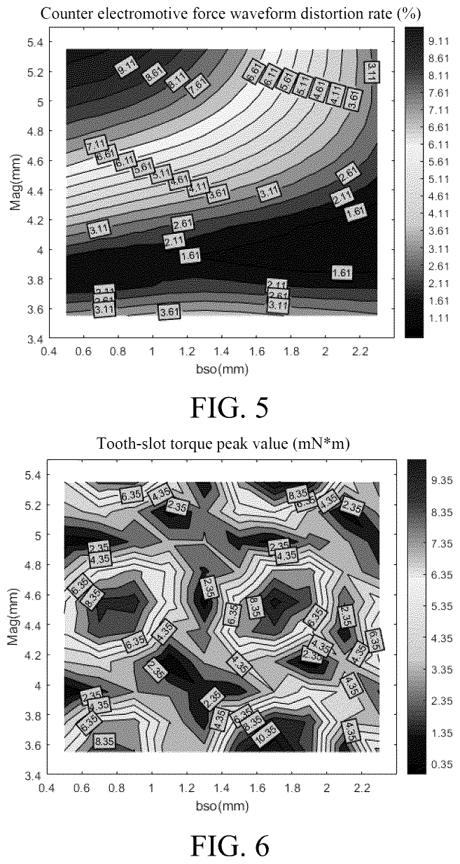

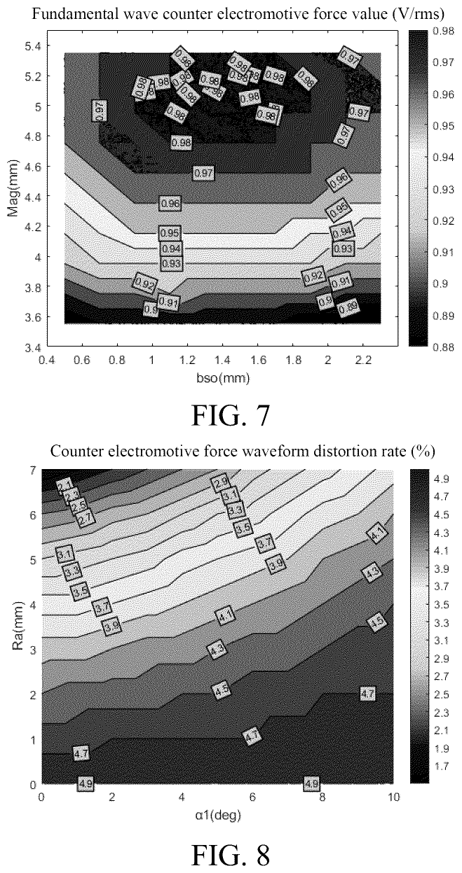

It should be noted that, in this embodiment, a fundamental wave counter electromotive force value of a traditional motor is 0.97V/rms, a counter electromotive force waveform distortion rate thereof is 7% and a tooth-slot torque peak value thereof is 6 mN*m. In FIG. 5, FIG. 6 and FIG. 7, when a preferred parameter is selected, for example, bso is 1.3 mm and Mag is 4.55 mm, the fundamental wave counter electromotive force value is 0.97V/rms, the counter electromotive force waveform distortion rate is 4.9% and the tooth-slot torque peak value is 0.8 mN*m. When the embodiments of the present disclosure are adopted, the tooth-slot torque peak value and the counter electromotive force waveform distortion rate of the outer rotor motor are lower than the traditional ones and the fundamental wave counter electromotive force value remains unchanged.

In this embodiment, to reduce the tooth-slot torque peak value and the counter electromotive force waveform distortion rate, a distance Ra between the center of the second arc segment 412 and the center of the third arc segment 413 and an arc angle α1 of the second arc segment 412 meet: The arc angle of the second arc segment 412 is α1 and 0<α1<0.86*LCM(12p,14p)*π/180, where LCM(12p, 14p) is a minimum keyway common multiple.

The arc angle of the second arc segment 412 is α1, the first arc segment 411 and the third arc segment 413 are symmetrically disposed at two ends of the second arc segment 412. The distance between the center of the second arc segment 412 and the center of the third arc segment 413 is Ra, where 0<Ra<2+α1.

When α1 and Ra meet the foregoing range, the tooth-slot torque peak value and the counter electromotive force waveform distortion rate of the outer rotor motor are further reduced and the fundamental wave counter electromotive force value remains unchanged.

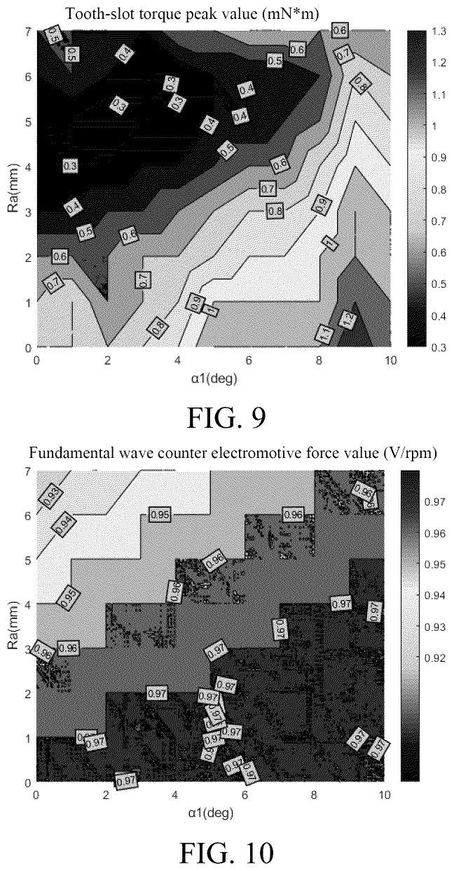

For example, the fundamental wave counter electromotive force value of the traditional motor is 0.97V/rms, the counter electromotive force waveform distortion rate thereof is 7% and the tooth-slot torque peak value thereof is 6 mN*m. In FIG. 8, FIG. 9 and FIG. 10, when a preferred parameter is selected, for example, α1 is 3° and Ra is 6 mm, the fundamental wave counter electromotive force value is 0.97V/rms, the counter electromotive force waveform distortion rate is 3.4% and the tooth-slot torque peak value is 0.4 mN*m. When the embodiments of the present disclosure are adopted, the tooth-slot torque peak value and the counter electromotive force waveform distortion rate of the motor are further reduced compared with the traditional ones and the fundamental wave counter electromotive force value remains unchanged.

As shown in FIG. 1 to FIG. 10, a center of an outer edge 210 of the permanent magnet rotor element 20 does not coincide with a center of the inner edge 220 of the permanent magnet rotor element 20. The outer edge 210 is a circular arc surface that is attached to an inner peripheral surface of the rotor magnet yoke 10. The inner edge 220 is a circular arc surface of the permanent magnet rotor element 20 away from the rotor magnet yoke 10.

Specifically, the plurality of permanent magnet rotor elements 20 are disposed at equal intervals in the circumferential direction of the rotor magnet yoke 10 to be disposed evenly on the inner peripheral surface of the rotor magnet yoke 10.

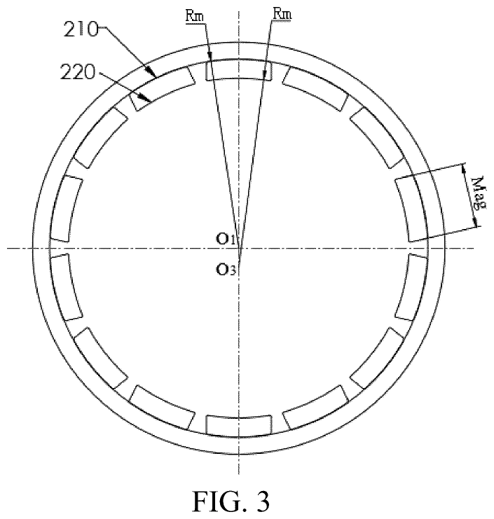

Further, a radius of the outer edge 210 of the permanent magnet rotor element 20 is equal to a radius of the inner edge 220. As shown in 01 in FIG. 3, the outer edge 210 of the permanent magnet rotor element 20 is concentric with the rotating shaft 30. O3 in FIG. 3 is the center of the inner edge 220 of the permanent magnet rotor element 20.

In this embodiment, inner and outer edges of each permanent magnet rotor element 20 include non-concentric circular arcs of a same radius and are of a tile-like structure in whole.

As shown in FIG. 1 to FIG. 10, a distance between the second arc segment 412 and the inner edge 220 of the permanent magnet rotor element 20 is less than a distance between each of the first arc segment 411 and the third arc segment 413 and the inner edge 220 of the permanent magnet rotor element 20.

Specifically, in a rotation process of the rotor assembly, when a center line of any stator tooth 40 coincides with a center line of the permanent magnet rotor element 20, a minimum air gap δmin is formed by a minimum radial distance between a midpoint of the second arc segment 412 and a midpoint of the inner edge 220 of the permanent magnet rotor element 20. A product of the minimum air gap δmin and the outer diameter of the stator tooth 40 is in a certain relationship with the minimum keyway common multiple LCM(12p, 14p), so as to maintain a relatively large fundamental wave counter electromotive force value and reduce the tooth-slot torque peak value. That is, 0.53≤δ min*LCM(12p,14p)/Dso≤1.06, where Dso is the diameter of the second arc segment 412 and LCM(12p, 14p) is the minimum keyway common multiple.

In this embodiment, the rotor magnet yoke 10 is of a circular ring structure and is composed of a soft magnetic material with relatively good magnetic conductivity, so as to maintain a relatively large fundamental wave counter electromotive force value.

Alternatively, the outer arc surface of the stator tooth has a first arc segment, a second arc segment and a third arc segment that are connected in sequence and centers of the first arc segment, the second arc segment and the third arc segment do not coincide.

Alternatively, the first arc segment and the third arc segment are symmetrically disposed at both ends of the second arc segment; and/or the first arc segment and the third arc segment are concentrically disposed; and/or a radius of curvature of the second arc segment is greater than a radius of curvature of the first arc segment and that of the third arc segment.

Alternatively, the plurality of stator teeth are disposed at equal intervals in the circumferential direction of the stator yoke to form a plurality of stator slots, the outer rotor motor further includes a stator winding, the stator winding is disposed around the stator teeth and runs through the stator slots, 14p permanent magnet rotor elements are disposed and 12p stator teeth are disposed; and a slot width of each stator slot meets 0.77*Dso*sin(7*p*π/(4*LCM(12p,14p))≤bso≤0.91*Dso*sin(7*p*π/(4*LCM(12p,14p)), where Dso is a diameter of the second arc segment and LCM(12p, 14p) is a minimum keyway common multiple.

Alternatively, the rotor assembly further includes a rotor magnet yoke, an outer edge of the permanent magnet rotor element is connected to the rotor magnet yoke and the outer edge of the permanent magnet rotor element does not coincide with a center of an inner edge of the permanent magnet rotor element.

Alternatively, a radius of the outer edge of the permanent magnet rotor element is equal to a radius of the inner edge of the permanent magnet rotor element, the rotor assembly further includes a rotating shaft and the outer edge is concentric with the rotating shaft.

Alternatively, the rotor assembly further includes a rotor magnet yoke, 14p permanent magnet rotor elements are disposed, 12p stator teeth are disposed, the plurality of permanent magnet rotor elements are disposed at equal intervals in an inner circumferential direction of the rotor magnet yoke and a width of the permanent magnet rotor element Mag is 0.81*Dso*π/(14p)≤Mag≤0.89*Dso*π/(14p), where Dso is a diameter of the second arc segment and LCM(12p, 14p) is a minimum keyway common multiple.

Alternatively, 14p permanent magnet rotor elements are disposed, 12p stator teeth are disposed and an arc angle of the second arc segment is α1 and 0<α1<0.86*LCM(12p,14p)*π/180, where LCM(12p, 14p) is a minimum keyway common multiple.

Alternatively, an arc angle of the second arc segment is α1, the first arc segment and the third arc segment are symmetrically disposed at two ends of the second arc segment and a distance between the center of the second arc segment and the center of the third arc segment is Ra, where 0<Ra<2+α1.

Alternatively, a distance between the second arc segment and an inner edge of the permanent magnet rotor element is less than a distance between each of the first arc segment and the third arc segment and the inner edge of the permanent magnet rotor element.

Alternatively, 14p permanent magnet rotor elements are disposed, 12p stator teeth are disposed, an air gap formed between the second arc segment and an inner edge of the permanent magnet rotor element is δmin, 0.53≤δmin*LCM(12p,14p)/Dso≤1.06, Dso is a diameter of the second arc segment and LCM(12p, 14p) is a minimum keyway common multiple.

Alternatively, the rotor assembly further includes a rotor magnet yoke and the rotor magnet yoke is a soft magnetic material.

### Embodiment 2

This embodiment provides an unmanned aerial vehicle apparatus. The unmanned aerial vehicle apparatus includes the outer rotor motor in Embodiment 1.

It may be learned from the foregoing description that the foregoing embodiments of the present disclosure implement the following technical effects:

In the outer rotor motor adopted in the present disclosure, because the first arc segment 411, the second arc segment 412 and the third arc segment 413 that are on the end surface of the stator tooth 40 facing the permanent magnet rotor element 20 are not concentric, the air gap 60 between the stator tooth 40 and the permanent magnet rotor element 20 is an uneven air gap 60 and compared with the prior art, the outer rotor motor in the present disclosure has relatively high power density and a tooth-slot torque peak value and a counter electromotive force distortion rate are lower.

The rotor magnet yoke 10 is composed of a soft magnetic material with relatively good magnetic conductivity, so as to maintain a relatively large fundamental wave counter electromotive force value.

Apparently, the described embodiments are only some embodiments rather than all the embodiments of the present disclosure. Based on the embodiments of the present disclosure, a person of ordinary skill in the art may make other different forms of changes or variations without creative efforts, which should fall within the protection scope of the present disclosure.

What is claimed is:

1. An outer rotor motor, comprising:
a rotor assembly, the rotor assembly comprising a plurality of permanent magnet rotor elements (20);
a stator assembly, the stator assembly comprising a stator yoke (70) and a plurality of stator teeth (40) disposed in a circumferential direction of the stator yoke (70); and
an air gap (60); the air gap (60) being configured to separate the rotor assembly and the stator assembly with a gap; wherein: in an air gap (60) between an outer arc surface of the stator tooth (40) facing the air gap (60) and an inner arc surface of the permanent magnet rotor element (20) facing the air gap (60), a gap of a middle section of the air gap (60) is less than gaps of two ends of the air gap (60).

2. The outer rotor motor according to claim 1, wherein
the outer arc surface of the stator tooth (40) has a first arc segment (411), a second arc segment (412) and a third arc segment (413) that are connected in sequence and a center of the first arc segment (411), a center of the second arc segment (412) and a center of the third arc segment (413) are not coincident.

3. The outer rotor motor according to claim 2, wherein
the first arc segment (411) and the third arc segment (413) are symmetrically disposed at both ends of the second arc segment (412); and/or
the first arc segment (411) and the third arc segment (413) are concentrically disposed; and/or
a radius of curvature of the second arc segment (412) is greater than a radius of curvature of the first arc segment (411) and that of the third arc segment (413).

4. The outer rotor motor according to claim 2, wherein the plurality of stator teeth (40) are disposed at equal intervals in the circumferential direction of the stator yoke (70) to form a plurality of stator slots, the outer rotor motor further comprises a stator winding (50), the stator winding (50) is disposed around the stator teeth (40) and runs through the stator slots, 14p permanent magnet rotor elements (20) are disposed and 12p stator teeth (40) are disposed; and
a slot width bso of each stator slot meets
0.77*Dso*sin(7*p*π/(4*LCM(12p,14p))≤bso≤0.91*Dso*sin(7*p*π/(4*LCM(12p,14p)), wherein Dso is a diameter of the second arc segment (412) and LCM(12p, 14p) is a minimum keyway common multiple.

5. The outer rotor motor according to claim 1, wherein the rotor assembly further comprises a rotor magnet yoke (10), an outer edge (210) of the permanent magnet rotor element (20) is connected to the rotor magnet yoke (10) and a center of the outer edge (210) of the permanent magnet rotor element (20) does not coincide with a center of an inner edge (220) of the permanent magnet rotor element (20).

6. The outer rotor motor according to claim 5, wherein a radius of the outer edge (210) of the permanent magnet rotor element (20) is equal to a radius of the inner edge (220) of the permanent magnet rotor element (20), the rotor assembly further comprises a rotating shaft (30) and the outer edge (210) is concentric with the rotating shaft (30).

7. The outer rotor motor according to claim 2, wherein the rotor assembly further comprises a rotor magnet yoke (10), 14p permanent magnet rotor elements (20) are disposed, 12p stator teeth (40) are disposed, the plurality of permanent magnet rotor elements (20) are disposed at equal intervals in an inner circumferential direction of the rotor magnet yoke (10) and a width of the permanent magnet rotor element (20) meets 0.81*Dso*π/(14p)≤Mag≤0.89*Dso*π/(14p),
wherein Dso is a diameter of the second arc segment (412) and LCM(12p, 14p) is a minimum keyway common multiple.

8. The outer rotor motor according to claim 2, wherein 14p permanent magnet rotor elements (20) are disposed, 12p stator teeth (40) are disposed and an arc angle of the second arc segment (412) is α1 and 0<α1<0.86*LCM(12p,14p)*π/180, wherein LCM(12p, 14p) is a minimum keyway common multiple.

9. The outer rotor motor according to claim 2, wherein an arc angle of the second arc segment (412) is α1, the first arc segment (411) and the third arc segment (413) are symmetrically disposed at two ends of the second arc segment (412) and a distance between the center of the second arc segment (412) and the center of the third arc segment (413) is Ra, wherein 0<Ra<2+α1.

10. The outer rotor motor according to claim 2, wherein a distance between the second arc segment (412) and an inner edge (220) of the permanent magnet rotor element (20) is less than a distance between each of the first arc segment (411) and the third arc segment (413) and the inner edge (220) of the permanent magnet rotor element (20).

11. The outer rotor motor according to claim 2, wherein 14p permanent magnet rotor elements (20) are disposed, 12p stator teeth (40) are disposed, an air gap (60) formed between the second arc segment (412) and an inner edge (220) of the permanent magnet rotor element (20) is δmin, 0.53≤δmin*LCM(12p,14p)/Dso≤1.06, Dso is a diameter of the second arc segment (412) and LCM(12p, 14p) is a minimum keyway common multiple.

12. The outer rotor motor according to claim 1, wherein the rotor assembly further comprises a rotor magnet yoke (10) and the rotor magnet yoke (10) is a soft magnetic material.

13. An unmanned aerial vehicle apparatus, wherein the unmanned aerial vehicle apparatus comprises the outer rotor motor, wherein the outer rotor motor, comprising:
a rotor assembly, the rotor assembly comprising a plurality of permanent magnet rotor elements (20);
a stator assembly, the stator assembly comprising a stator yoke (70) and a plurality of stator teeth (40) disposed in a circumferential direction of the stator yoke (70); and
an air gap (60); the air gap (60) being configured to separate the rotor assembly and the stator assembly with a gap; wherein: in an air gap (60) between an outer arc surface of the stator tooth (40) facing the air gap (60) and an inner arc surface of the permanent magnet rotor element (20) facing the air gap (60), a gap of a middle section of the air gap (60) is less than gaps of two ends of the air gap (60).

14. The unmanned aerial vehicle apparatus according to claim 13, wherein
the outer arc surface of the stator tooth (40) has a first arc segment (411), a second arc segment (412) and a third arc segment (413) that are connected in sequence and a center of the first arc segment (411), a center of the second arc segment (412) and a center of the third arc segment (413) are not coincident.

15. The unmanned aerial vehicle apparatus according to claim 14, wherein
the first arc segment (411) and the third arc segment (413) are symmetrically disposed at both ends of the second arc segment (412); and/or
the first arc segment (411) and the third arc segment (413) are concentrically disposed; and/or
a radius of curvature of the second arc segment (412) is greater than a radius of curvature of the first arc segment (411) and that of the third arc segment (413).

16. The unmanned aerial vehicle apparatus according to claim 14, wherein the plurality of stator teeth (40) are disposed at equal intervals in the circumferential direction of the stator yoke (70) to form a plurality of stator slots, the outer rotor motor further comprises a stator winding (50), the stator winding (50) is disposed around the stator teeth (40) and runs through the stator slots, 14p permanent magnet rotor elements (20) are disposed and 12p stator teeth (40) are disposed; and
a slot width bso of each stator slot meets
0.77*Dso*sin(7*p*π/(4*LCM(12p,14p))≤bso≤0.91*Dso*sin(7*p*π/(4*LCM(12p,14p)), wherein Dso is a diameter of the second arc segment (412) and LCM(12p, 14p) is a minimum keyway common multiple.

17. The unmanned aerial vehicle apparatus according to claim 13, wherein the rotor assembly further comprises a rotor magnet yoke (10), an outer edge (210) of the permanent magnet rotor element (20) is connected to the rotor magnet yoke (10) and a center of the outer edge (210) of the permanent magnet rotor element (20) does not coincide with a center of an inner edge (220) of the permanent magnet rotor element (20).

18. The unmanned aerial vehicle apparatus according to claim 17, wherein a radius of the outer edge (210) of the permanent magnet rotor element (20) is equal to a radius of the inner edge (220) of the permanent magnet rotor element (20), the rotor assembly further comprises a rotating shaft (30) and the outer edge (210) is concentric with the rotating shaft (30).

19. The unmanned aerial vehicle apparatus according to claim 14, wherein the rotor assembly further comprises a rotor magnet yoke (10), 14p permanent magnet rotor elements (20) are disposed, 12p stator teeth (40) are disposed, the plurality of permanent magnet rotor elements (20) are disposed at equal intervals in an inner circumferential direction of the rotor magnet yoke (10) and a width of the permanent magnet rotor element (20) meets 0.81*Dso*π/(14p)≤Mag≤0.89*Dso*π/(14p),
wherein Dso is a diameter of the second arc segment (412) and LCM(12p, 14p) is a minimum keyway common multiple.

20. The unmanned aerial vehicle apparatus according to claim 14, wherein 14p permanent magnet rotor elements (20) are disposed, 12p stator teeth (40) are disposed and an arc angle of the second arc segment (412) is α1 and 0<α1<0.86*LCM(12p,14p)*π/180, wherein LCM(12p, 14p) is a minimum keyway common multiple.
